(19) United States
(12) Patent Application Publication
(10) Pub. No.: US 2008/0144228 A1
(43) Pub. Date: Jun. 19, 2008

(54) MAGNETIC HEAD AND MAGNETIC DISK APPARATUS

(75) Inventor: Tomomi Funayama, Tokorozawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/955,805

(22) Filed: Dec. 13, 2007

(30) Foreign Application Priority Data
Dec. 14, 2006 (JP) 2006-337097

(51) Int. Cl. G11B 5/33

(52) U.S. Cl. 360/314

(57) ABSTRACT

According to one embodiment, a magnetic head includes a magnetoresistance element including a first spin valve layer, a bias layer, and a second spin valve layer sequentially arranged in the track direction, the first spin valve layer having a first magnetization free layer including a ferromagnetic film, the second spin valve layer having a second magnetization free layer having a ferromagnetic film, and the bias layer having a magnetic layer to apply a bias magnetic field, in a direction of track width orthogonal to the track direction, to the first magnetization free layer and the second magnetization free layer, and a pair of electrodes to cause a current, having a direction almost parallel to the track direction, to flow into the magnetoresistance element.

### CROSS-REFERENCE TO RELATED APPLICATION

This application is based upon and claims the benefit of priority from Japanese Patent Application No. 2006-337097, filed Dec. 14, 2006, the entire contents of which are incorporated herein by reference.

### BACKGROUND

1. Field

One embodiment of the present invention relates to a magnetic head which causes a sense current to perpendicularly flow from one pair of electrodes to a spin valve film surface in a sensing state, and a magnetic disk apparatus.

2. Description of the Related Art

In recent years, density growth in a magnetic recording/reproducing apparatus such as an HDD (Hard Disk Drive) is rapidly advanced. Accordingly, a magnetic head coping with a high recording density is required.

At present, a magnetic head using a spin valve type magnetoresistance element which causes a magnetoresistance is main stream. The spin valve type magnetoresistance film has a laminate structure constituted by a magnetization of pinned layer (pin layer)/intermediate layer (spacer layer)/magnetization of free layer (free layer).

As the magnetoresistance film, a so-called CPP (Current-Perpendicular-to-Plane) type configuration in which a sense current is caused to perpendicularly flow from one pair of electrodes to a spin valve film surface in a sensing state is known (U.S. Pat. No. 6,643,103 (FIG. 7)).

In the magnetic head described in the above document, a bias magnetic field is applied to a magnetization free layer in a direction of a track width by one pair of permanent magnets arranged independently of a magnetoresistance element. However, this structure is disadvantageous to a narrow track, and is difficult to increase a recording density of a medium.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a sectional view showing a configuration of a magnetic head including a recording head and a reproducing head according to an embodiment of the present invention;

FIG. 2 is a sectional view showing a configuration of a part cut along a line I-I in the magnetic head shown in FIG. 1;

FIG. 3 is a perspective view showing a configuration of a magnetoresistance element portion of the reproducing head shown in FIG. 1;

FIG. 4 is a perspective view for explaining a magnetic bias of the reproducing head;

FIG. 5A, FIG. 5B, FIG. 5C, FIG. 5D, and FIG. 5E are diagrams used in explanation of an operation of the reproducing head;

FIG. 6A and FIG. 6B are diagrams showing a relationship between a width (W) of a bias film and a magnitude of a magnetic field applied to a magnetization free layer;

FIG. 7 is a perspective view of a magnetic recording/reproducing apparatus according to an embodiment of the present invention; and

FIG. 8 is a perspective view of a magnetic head assembly according to an embodiment of the present invention.

### DETAILED DESCRIPTION

Various embodiments according to the invention will be described hereinafter with reference to the accompanying drawings. In general, according to one embodiment of the invention, a magnetic head comprises a magnetoresistance element which has a air bearing surface opposing a medium on which information is magnetically recorded in a track direction, and which has a first spin valve layer, a bias layer, and a second spin valve layer sequentially arranged in the track direction, the first spin valve layer having a first magnetization free layer including a ferromagnetic film, a first magnetization of pinned layer including a ferromagnetic film having a pinned direction of magnetization, and a first non-magnetic intermediate layer arranged between the first magnetization free layer and the first magnetization of pinned layer, the second spin valve layer having a second magnetization free layer having a ferromagnetic film, a second magnetization of pinned layer having a ferromagnetic film having a fixed direction of magnetization, and a second non-magnetic intermediate layer arranged between the second magnetization free layer and the second magnetization of pinned layer, and the bias layer having a magnetic layer to apply a bias magnetic field, in a direction of track width orthogonal to the track direction, to the first magnetization free layer and the second magnetization free layer, and a pair of electrodes to cause a current, having a direction almost parallel to the track direction, to flow into the magnetoresistance element.

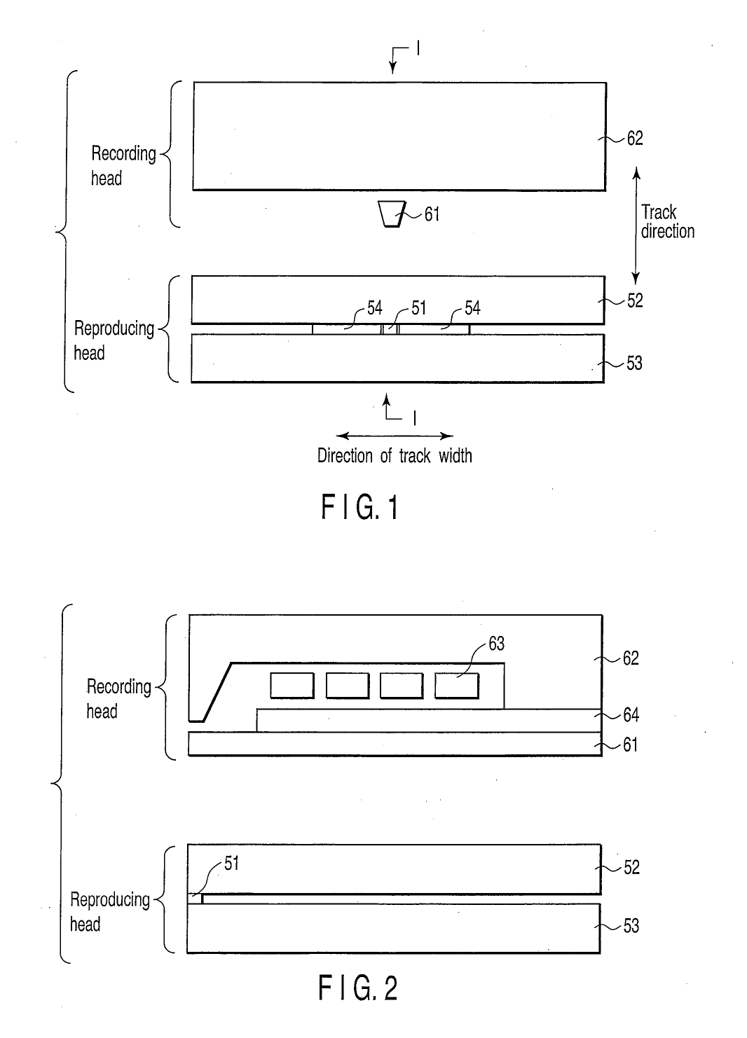

FIG. 1 is a sectional view showing a configuration of a magnetic head including a recording head and a reproducing head according to an embodiment of the present invention. In FIG. 1, a section on a front side on paper is an air bearing surface (ABS). FIG. 2 is a sectional view showing a configuration of a part cut along a line I-I in the magnetic head shown in FIG. 1.

As shown in FIGS. 1 and 2, the magnetic head has a recording head 1, a reproducing head 2, and the like. On a section of the recording head 1 when viewed from an ABS surface, a main magnetic pole 61 and a return yoke 62 are exposed. On a section of the reproducing head 2 viewed from the ABS surface, an upper electrode 52, a lower electrode 53, a magnetoresistance element 51, and a side shield 54 are exposed. The magnetoresistance element 51 and the side shield 54 are interposed between the upper electrode 52 and the lower electrode 53.

In a sensing state, a current flows in the magnetoresistance element 51 in a track direction by the upper electrode 52 and the lower electrode 53.

As shown in the sectional view in FIG. 2, the recording head 1 is constituted by the main magnetic pole 61 consisting of a magnetic material, a coil 63 for exciting consisting of a conductive material such as Cu, and the return yoke 62 connected to the main magnetic pole 61 through an auxiliary magnetic pole 64 and consisting of a magnetic material.

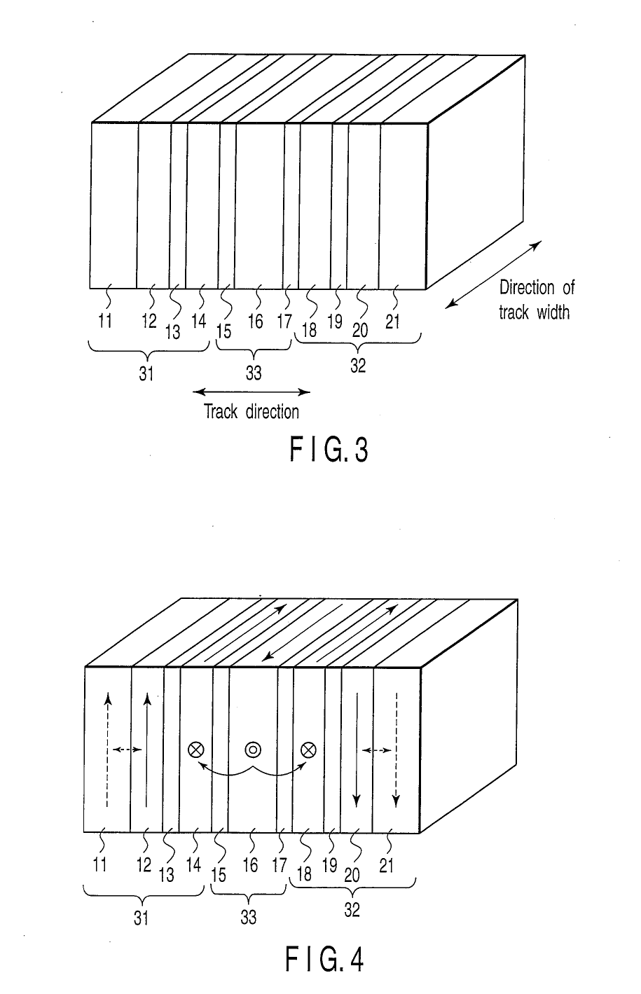

The magnetoresistance element 51 of the reproducing head 2 will be described below. FIG. 3 is a perspective view of the magnetoresistance element 51 part of the reproducing head 2 according to an embodiment of the present invention. The magnetoresistance element 51 has a first spin valve 31, a second spin valve 32, and a bias layer 33 interposed between the two spin valves. The first spin valve 31, the bias layer 33, and the second spin valve 32 are sequentially arranged along a track direction.

The first spin valve 31 is constituted by a first antiferromagnetic layer 11, a first magnetization of pinned layer 12, a first non-magnetic intermediate layer 13, and a first magnetization of free layer 14. The second spin valve 32 is constituted by a second magnetization free layer 18, a second non-magnetic intermediate layer 19, a second magnetization of pinned layer 20, and a second antiferromagnetic layer 21. The bias layer 33 is constituted by a first non-magnetic layer 15, a second non-magnetic layer 17, and a magnetic layer 16 interposed between the first non-magnetic layer 15 and the second non-magnetic layer 17. The first magnetization free layer 14 and the second magnetization free layer 18 are oppositely arranged to interpose the first non-magnetic layer 15, the magnetic layer 16, and the second non-magnetic layer 17.

As constituent materials of the first antiferromagnetic layer 11 and the second antiferromagnetic layer 21, IrMn, PtMn, NiMn, RhMn, nickel oxide, cobalt oxide, iron oxide, and the like may be used. A blocking temperature may be changed by using different materials for the first antiferromagnetic layer 11 and the second antiferromagnetic layer 21, changing compositions of the layers, or changing film thicknesses of the layers.

The first magnetization free layer 14 and the second magnetization free layer 18 can be constituted by a single layer or a plurality of layers including films containing any one of Fe, Co, and Ni. For example, CoFe, NiFe, CoFeB, CoFe/NiFe, CoFe/CoFeB/NiFe, or the like can be used.

The first magnetization of pinned layer 12 and the second magnetization of pinned layer 20 can be constituted by a single layer or a plurality of layers including films containing any one of Fe, Co, and Ni. The first magnetization of pinned layer 12 and the second magnetization of pinned layer 20 can also be constituted by a simple pin layer or a structure obtained by sandwiching Ru, Rh, Cr, or the like between films containing any one of Fe, Co, and Ni, namely, so-called synthetic pin layer (for example, CoFe/Ru/CoFe or the like). In particular, when one of the first magnetization of pinned layer 12 and the second magnetization of pinned layer 20 is constituted by a simple pin layer and the other is constituted by a synthetic pin layer, directions of the magnetization of pinned layer s of the first spin valve 31 and the second spin valve 32 can be antiparallel to each other.

As the first non-magnetic intermediate layer 13 and the second non-magnetic intermediate layer 19, a non-magnetic metal such as Cu, Ag, Au or the like or tunnel films consisting of AlOₓ, TiOₓ, MgOₓ, or the like can be used.

As the magnetic layer 16, a hard magnetic film consisting of CoPt, CoCrPt, or the like or an antiferromagnetic film consisting of IrMn, PtMn, NiMn, RhMn, nickel oxide, cobalt oxide, iron oxide, or the like can be used.

The first non-magnetic layer 15 and the second non-magnetic layer 17 are not essential components. In the embodiment, Ta is used in the non-magnetic layers 15 and 17 on the assumption that the magnetic layer 16 uses CoPt of a hard magnetic film. Ru, Cu, W, Mo, Zr, or the like may be used in place of Ta. When the antiferromagnetic layer is used as the magnetic layer 16, the non-magnetic layers 15 and 17 need not be used, or, in place of the non-magnetic layers 15 and 17, a magnetic layer consisting of NiFe or the like or a laminate film constituted by non-magnetic/magnetic layers may be used.

FIG. 4 is a perspective view for explaining a magnetic bias of the magnetoresistance reproducing head according to the embodiment. The film composition in FIG. 4 is the same as in FIG. 3. In FIG. 4, an ABS is on the lower side. A direction of magnetization of the first magnetization of pinned layer 12 of the first spin valve 31 is pinned from bottom to top perpendicularly to the ABS. A direction of magnetization of the second magnetization of pinned layer 20 of the second spin valve 32 is pinned from top to bottom perpendicularly to the ABS. More specifically, the direction of magnetization of the first magnetization of pinned layer 12 and the direction of magnetization of the second magnetization of pinned layer 20 are antiparallel to each other. In order to realize such orientation of magnetization, blocking temperatures of the first antiferromagnetic layer 11 of the first spin valve 31 and the second antiferromagnetic layer 21 of the second spin valve 32 are made different from each other, heat treatment in magnetic fields is performed by changing directions of the magnetic fields at temperatures of two conditions.

The magnetic layer 16 is a hard magnetic film, and is magnetized in a direction parallel to the ABS. The direction of magnetization of the first magnetization free layer 14 and the direction of magnetization of the second magnetization free layer 18 are parallel to the ABS and antiparallel to the direction of magnetization of the magnetic layer 16 by magnetostatic coupling between the direction of magnetization of the magnetic layer 16 and the directions of magnetization of the first magnetization free layer 14 and the second magnetization free layer 18. In this manner, an angle between the directions of magnetization of the first magnetization free layer 14 and the first magnetization of pinned layer 12 of the first spin valve 31 and an angle between the directions of magnetization of the second magnetization free layer 18 and the second magnetization of pinned layer 20 of the second spin valve 32 are almost 90° each when a media magnetic field does not act.

In this manner, in a reproducing head using the magnetoresistance element 51, preferable bias magnetic fields can be applied to the magnetization free layers of the spin valve. As a result, excellent linear response and a reduction in Barkhausen noise can be achieved.

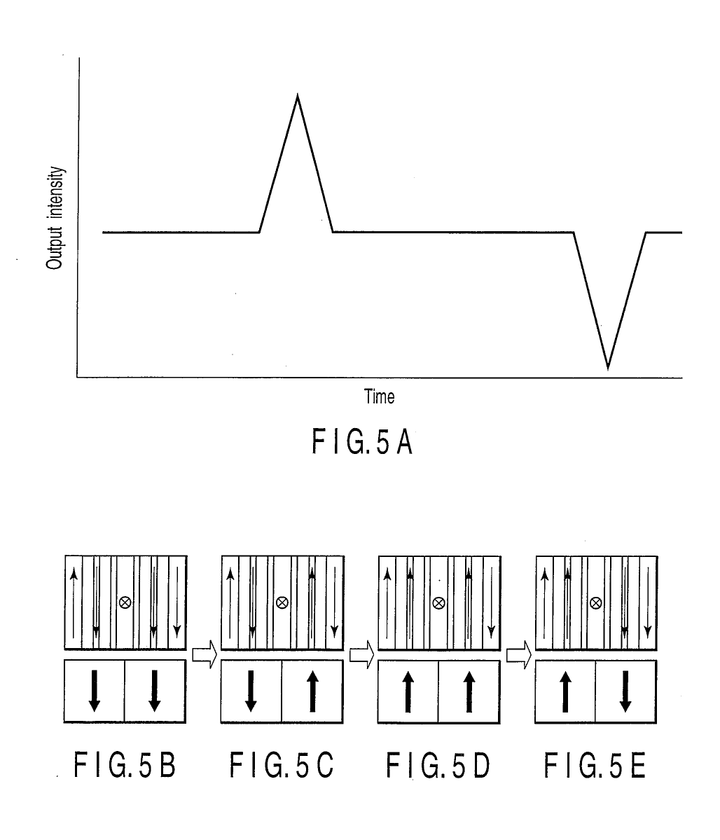

FIGS. 5A to 5E are diagrams for explaining an operation of a magnetoresistance type reproducing head. FIG. 5A shows a signal output from the reproducing head. In each of FIGS. 5B to 5D, a lower half shows adjacent recording bits, and an upper half shows states of the magnetization free layers 14 and 18 in which directions of magnetization change depending on external magnetic fields obtained by the adjacent recording bits.

As shown in FIGS. 5B and 5D, both directions of media magnetic fluxes applied to the magnetization free layers 14 and 18 of the two spin valves 31 and 32 are downward or upward, one of the spin valve has antiparallel magnetization to have a high magnetoresistance, and the other spin valve has parallel magnetization to have a low magnetoresistance. On the other hand, as shown in FIG. 5C, when the directions of media magnetic fluxes applied to the magnetization free layer portions of the two spin valves are different from each other, i.e., when a downward media magnetic flux acts on the magnetization free layer portion of the left spin valve and an upward media magnetic flux acts on the magnetization free layer portion of the right spin valve, both the spin valves have antiparallel magnetization to have high resistances. As shown in FIG. 5E, when an upward media magnetic flux acts on the magnetization free layer portion of the left spin valve and a downward media magnetic flux acts on the magnetization free layer portion of the right spin valve, both the spin valves have parallel magnetization to have low resistances. Therefore, as shown in FIG. 5A, a point where the directions of magnetization of the media change, a signal generated by a change in output can be detected.

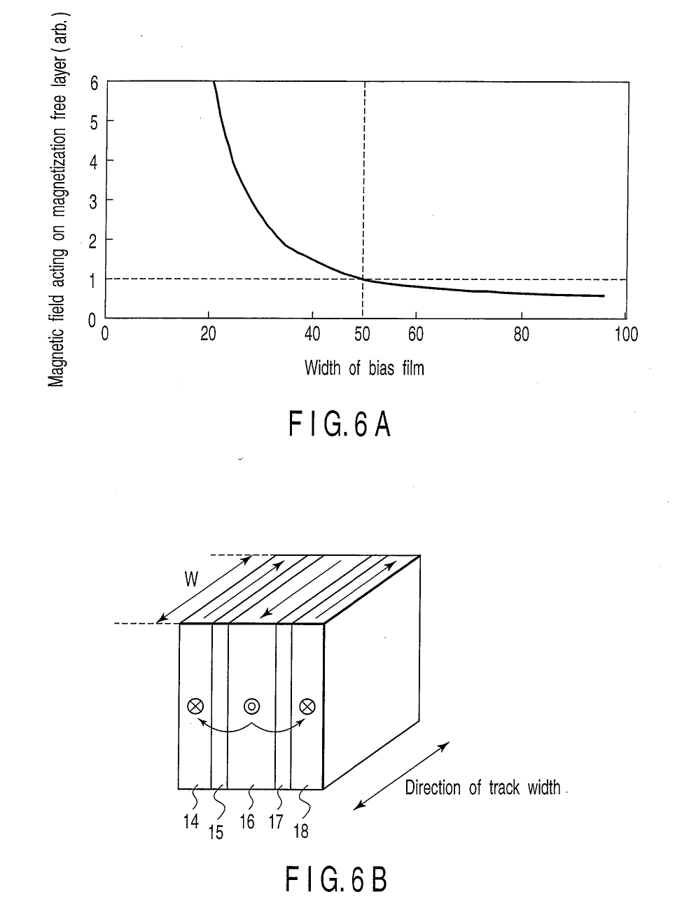

FIGS. 6A and 6B show a relationship between a width (W) of a bias film and an intensity of a magnetic field applied to a magnetization free layer. FIG. 6B is a diagram for explaining definition of the width (W) of the bias film. As shown in FIG. 6B, a direction of a track width almost perpendicular to a track direction is defined as the width (W) of the bias film.

In FIG. 6A, on the ordinate, a magnetic field required to apply a preferable bias to a magnetization free layer is defined as 1. According to this, a necessary magnetic field can be generated at about 50 nm.

When the width is longer than 50 nm, the bias may be unstable because the magnetic field is slightly short. However, when the width is equal to or smaller than 50 nm, a sufficient bias magnetic field can be applied. Therefore, the element width (width of the bias film) is preferably 50 nm or less.

A magnetic reproducing apparatus having mounted thereon a magnetoresistance element according to the embodiment of the present invention will be described below. A magnetoresistance element or a magnetic head according to the embodiment of the present invention is incorporated in, for example, a recording/reproducing-integrated magnetic head assembly and can be mounted on a magnetic recording/reproducing apparatus.

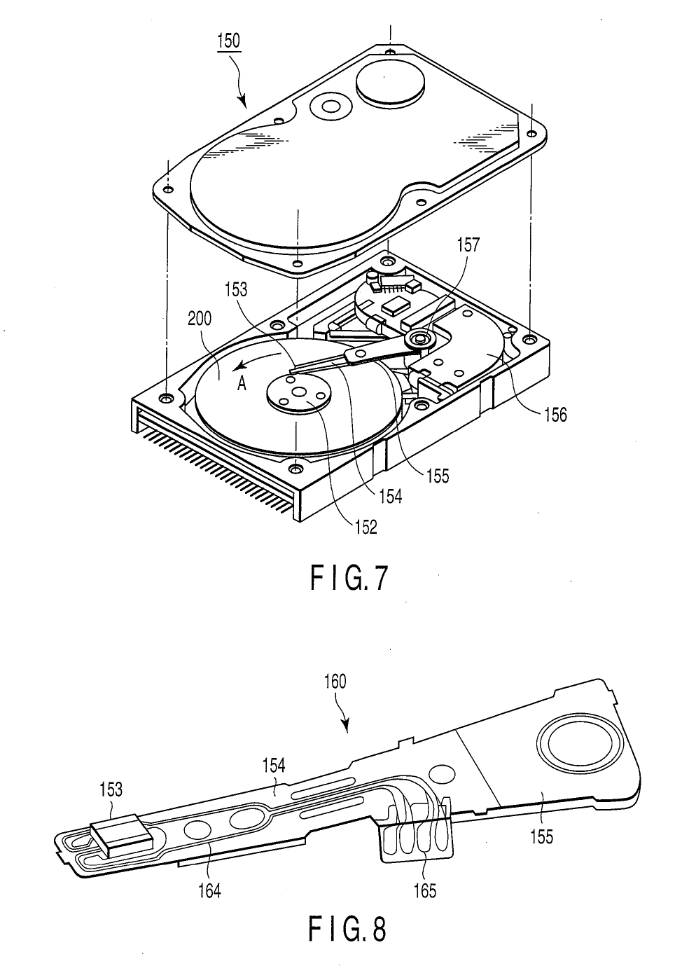

FIG. 7 is a main perspective view illustrating a schematic configuration of the magnetic recording/reproducing apparatus. More specifically, a magnetic recording/reproducing apparatus 150 is an apparatus of a type using a rotary actuator. In FIG. 7, a magnetic disk 200 is mounted on a spindle 152 and rotated in a direction of an arrow A by a motor (not shown) which responds to a control signal from a drive apparatus control unit (not shown). The magnetic recording/reproducing apparatus 150 of the invention may include a plurality of magnetic disks 200.

A head slider 153 which records and reproduces information stored in the magnetic disk 200 is fixed to the tip of the suspension 154. The magnetic head including the reproducing head and the recording head is mounted near the tip of the head slider 153.

When the magnetic disk 200 is rotated, a air bearing surface (ABS) of the head slider 153 is kept with a predetermined floating amount from the surface of the magnetic disk 200. Alternatively, the slider may be of a so-called “contact slider type” in which the slider is brought into contact with the magnetic disk 200.

The suspension 154 is connected to one end of an actuator arm 155 having a bobbin unit which holds a drive coil (not shown). A voice coil motor 156 which is a kind of linear motor is arranged at the other end of the actuator arm 155. The voice coil motor 156 is constituted by a drive coil (not shown) wound around the bobbin unit of the actuator arm 155 and a magnetic circuit including a permanent magnet and an opposite yoke which are oppositely arranged to interpose the coil.

The actuator arm 155 is held by ball bearings (not shown) arranged at two upper and lower positions of a spindle 157, and designed to be freely rotated and slid by the voice coil motor 156.

FIG. 8 is an enlarged perspective view of a magnetic head assembly ahead of the actuator arm 155 when viewed from a disk side. More specifically, a magnetic head assembly 160 has an actuator arm 155 having a bobbin unit or the like holding, for example, a drive coil. The suspension 154 is connected to one end of the actuator arm 155.

At the tip of the suspension 154, the head slider 153 provided with the magnetic head is fixed. The suspension 154 has a lead wire 164 for writing and reading signals. The lead wire 164 is electrically connected to electrodes of the magnetic head incorporated in the head slider 153. Reference numeral 165 in FIG. 8 denotes an electrode pad of the magnetic head assembly 160.

When the apparatus includes the magnetic reproducing head, information which is magnetically recorded on the magnetic disk 200 at a recording density higher than that of a conventional magnetic disk can be reliably read.

As described in detail, by using the magnetoresistance head according to the present invention, a narrow-gap/narrow-track disk drive can be realized to make it possible to increase a recording density and to apply a preferable bias magnetic field. For this reason, a preferable linear operation and a reduction in noise can be achieved, and a reproduced signal having a high S/N ratio can be obtained.

Since the recording head 1 is perpendicularly energized, the upper and lower electrodes 52 and 53 are arranged above and below the magnetoresistance element 51, and a bias-applied film is arranged in the magnetoresistance element 51. Therefore, the side shields 54 and 55 can be arranged on a transverse side in the direction of track width. In this manner, the side shields are arranged to make it possible to reduce signals from adjacent tracks, and an effective reproducing track width decreases to make it possible to realize a narrow track.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic head comprising:
a magnetoresistance element which has a air bearing surface opposing a medium on which information is magnetically recorded in a track direction, and which has a first spin valve layer, a bias layer, and a second spin valve layer sequentially arranged in the track direction, the first spin valve layer having a first magnetization free layer including a ferromagnetic film, a first magnetization of pinned layer including a ferromagnetic film having a pinned direction of magnetization, and a first non-magnetic intermediate layer arranged between the first magnetization free layer and the first magnetization of pinned layer, the second spin valve layer having a second magnetization free layer having a ferromagnetic film, a second magnetization of pinned layer having a ferromagnetic film having a fixed direction of magnetization, and a second non-magnetic intermediate layer arranged between the second magnetization free layer and the second magnetization of pinned layer, and the bias layer having a magnetic layer to apply a bias magnetic field, in a direction of track width orthogonal to the track direction, to the first magnetization free layer and the second magnetization free layer; and
a pair of electrodes to cause a current, having a direction almost parallel to the track direction, to flow into the magnetoresistance element.

2. The magnetic head according to claim 1, wherein the magnetic layer is a hard magnetic film.

3. The magnetic head according to claim 2, further comprising a first non-magnetic layer and a second non-magnetic layer arranged between the first magnetization free layer and the second magnetization free layer,
wherein the magnetic layer is arranged between the first non-magnetic layer and the second non-magnetic layer.

4. The magnetic head according to claim 1, wherein the magnetic layer is an antiferromagnetic film.

5. The magnetic head according to claim 1, wherein a side shield is arranged adjacent to the magnetoresistance element on a side almost parallel to the direction of track width.

6. The magnetic head according to claim 1, wherein a width of the bias layer in the direction of track width is 50 nm or less.

7. A magnetic disk apparatus comprising
a magnetic head including: a magnetoresistance element which has a media opposite surface opposing a medium on which information is magnetically recorded in a track direction, and which has a first spin valve layer, a bias layer, and a second spin valve layer sequentially arranged in the track direction, the first spin valve layer having a first magnetization free layer having a ferromagnetic film, a first magnetization of pinned layer having a ferromagnetic film having a fixed direction of magnetization, and a first non-magnetic intermediate layer arranged between the first magnetization free layer and the first magnetization of pinned layer, the second spin valve layer having a second magnetization free layer having a ferromagnetic film, a second magnetization of pinned layer having a ferromagnetic film having a fixed direction of magnetization, and a second non-magnetic intermediate layer arranged between the second magnetization free layer and the second magnetization of pinned layer, and the bias layer having a magnetic layer to apply a bias magnetic field, in a direction of track width orthogonal to the track direction, to the first magnetization free layer and the second magnetization free layer; and a pair of electrodes to cause a current, having a direction almost parallel to the track direction, to flow into the magnetoresistance element.

8. The magnetic disk apparatus according to claim 7, wherein the magnetic layer is a hard magnetic film.

9. The magnetic disk apparatus according to claim 8, further comprising a first non-magnetic layer and a second non-magnetic layer arranged between the first magnetization free layer and the second magnetization free layer,
wherein the magnetic layer is arranged between the first non-magnetic layer and the second non-magnetic layer.

10. The magnetic disk apparatus according to claim 7, wherein the magnetic layer is an antiferromagnetic layer.

11. The magnetic disk apparatus according to claim 7, wherein a side shield is arranged adjacent to the magnetoresistance element on a side almost parallel to the direction of track width.

12. The magnetic disk apparatus according to claim 7, wherein a width of the bias layer in the direction of track width is 50 nm or less.
